(19) United States
(12) Patent Application Publication
(10) Pub. No.: US 2010/0116970 A1
(43) Pub. Date: May 13, 2010

(54) Photo detection device

(76) Inventors: Wen-Long Chou, Hsinchu (TW); Ni-Ting Chu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,060

(22) Filed: Nov. 12, 2008

(51) Int. Cl. H01J 40/14

(52) U.S. Cl. 250/214 R

(57) ABSTRACT

A photo detection device includes a first lead frame, a second lead frame, a photo detection die having a coating layer, and an enclosure. The first lead frame forms a carriage section. The coating layer is formed on the photo detection die. The photo detection die is mounted on the carriage section of the first lead frame and forms electrical connection with the second lead frame through a conductor. The enclosure is a non-light-transmittable member forming therein a receiving space. The enclosure is mounted on the first and second lead frames and receives the photo detection die in the receiving space thereof. The enclosure forms an opening for light detection by the photo detection die. As such, detection of a long wavelength invisible light, such as an infrared light, by the photo detection die can be prevented to thereby provide a photo detection device with increased reliability of detection.

### FIELD OF THE INVENTION

The present invention relates to a photo detection device, and in particular to a photo detection device that eliminates the influence on a photo detection die by long wavelength invisible lights, such as infrared light to ensure high detection reliability of visible lights and that is applicable to a photo sensor or the likes.

### BACKGROUND OF THE INVENTION

Conventional photo detection devices comprise photo detection dies that are exposed outside the devices or are housed by light-transmitting plastic materials, such as epoxy resin. Consequently, the photo detection die receives both visible lights and invisible lights from all directions. In certain applications of the photo detection device, it is desired to detect if the device is radiated by visible lights by using the photo detection die and to further transmit the result of detection to other devices to induce a corresponding operation. For example, in the application in an automobile, when the automobile travels through a tunnel or an area of insufficient lighting, a central control of the automobile may receive the detection result provided by a photo detection device mounted outside the automobile body to signal the driver of the automobile to turn on the automobile lights or to perform automatic actuation of the automobile lights in order to ensure driving safety.

A conventional photo detection device A (see FIG. 6) comprises a photo detection die A1, which has a surface formed with a coating layer. In practice, the photo detection die A1 is housed in a light-transmitting plastic material A2 to allow the photo detection die A1 to receive light B that includes both visible components and invisible components from various directions and angles. When an incident light component of the light B having a long wavelength, such as an infrared light, transmits through the coating layer formed on the surface of the photo detection die A1, error detection is caused to give an incorrect result of detection, so that a device that receives the incorrect result of detection cannot respond properly.

To solve the problems of the conventional photo detection device A, the present inventor conducted extensive study and research and performed experiments that reveal that the photo detection die A1 provided different result of detection when receiving long wavelength incident lights (such as an invisible light, for example an infrared light) from different angles. It is also found that the greater an incidence angle of a long wavelength incident light (such as an invisible light, for example an infrared light), the more easily the light transmits through the surface coating layer of the photo detection die A1 to be detected by the photo detection die A1, causing error detection, wherein the term “incidence angle” used here is defined as an included angle between an incident light beam and a line perpendicular to the surface of the photo detection die, namely an included angle between the incident light beam and the normal of the surface of the photo detection die. The present invention provides a solution to improve the conventional photo detection device A on the basis of the above observation.

### SUMMARY OF THE INVENTION

An objective of the present invention is to provide a photo detection device, which reduces error detection caused by a long wavelength incident light (such as an invisible light, for example an infrared light) transmitting through a surface coating layer of a photo detection die by means of providing an assembly comprising the photo detection die housed in a non-light-transmittable enclosure with the enclosure forming an opening for the transmission of the light to limit the incidence angle by which the photo detection die receives the light, so as to improve detection reliability of visible lights and thus enhance the practicability of the present invention.

Another objective of the present invention is to provide a photo detection device, which reduces error detection caused by a long wavelength component (such as an infrared component) contained in an incident light that transmits through a coating layer of a photo detection die due to a large incidence angle thereof by means of providing an assembly comprising the photo detection die housed in a non-light-transmittable enclosure that forms an opening for the transmission of the light, wherein the opening is made size-reduced for reducing the incidence angle, so as to improve detection reliability and thus enhance the practicability of the present invention.

A further objective of the present invention is to provide a photo detection device, which reduces error detection caused by a long wavelength component of an incident light, such as an infrared component, that transmits through a coating layer of a photo detection die due to a large incidence angle thereof by means of providing an assembly comprising the photo detection die housed in a non-light-transmittable enclosure that forms an opening for the transmission of the light and has an increased height to increase the distance between the opening and the photo detection die for reducing the incidence angle by which the incident light that enters the enclosure is incident onto the photo detection die, so as to improve detection reliability and thus enhance the practicability of the present invention.

Yet a further objective of the present invention is to provide a photo detection device, which effectively reduces the reflection of a long wavelength incident light (such as an invisible light, for example an infrared light) by a photo detection die by providing an assembly comprising the photo detection die housed in a non-light-transmittable enclosure that forms an opening for the transmission of the light with a coating layer that is formed by either a layer of titanium dioxide (TiO₂), a layer of silicon dioxide (SiO₂), a stack of at least one layer of titanium dioxide (TiO₂) and at least one layer of silicon dioxide (SiO₂), or a Bragg reflection film being provided on the photo detection die, so as to reduce the occurrence of error detection and improve detection reliability to thereby enhance the practicability of the present invention.

To realize the above objectives, the present invention provides a photo detection device comprising two lead frames, a photo detection die, and an enclosure. The two lead frames include a first lead frame and a second lead frame. The first lead frame forms a carriage section. A coating layer is formed on the photo detection die. The photo detection die is mounted on the carriage section of the first lead frame and forms electrical connection with the second lead frame through a conductor. The enclosure is a non-light-transmittable member forming therein a receiving space. The enclosure is mounted on the first and second lead frames and receives the photo detection die in the receiving space thereof. The enclosure forms an opening for light detection by the photo detection die. As such, detection of a long wavelength invisible light, such as an infrared light, by the photo detection die can be prevented to thereby provide a photo detection device with increased reliability of detection.

### BRIEF DESCRIPTION OF THE DRAWINGS

The present invention will be apparent to those skilled in the art by reading the following description of preferred embodiments thereof with reference to the drawings, in which:

FIG. 1 is a perspective view illustrating a photo detection device in accordance with the present invention;

FIG. 2 is a cross-sectional view illustrating a first embodiment of a coating layer of a photo detection die incorporated in the photo detection device in accordance with the present invention;

FIG. 3 is a cross-sectional view illustrating a second embodiment of a coating layer of a photo detection die incorporated in the photo detection device in accordance with the present invention;

FIG. 4 is a perspective view illustrating a photo detection device in accordance with another embodiment of the present invention;

FIG. 5 is a perspective view illustrating a photo detection device in accordance with a further embodiment of the present invention; and

FIG. 6 is a schematic view illustrating the operation of a conventional photo detection device.

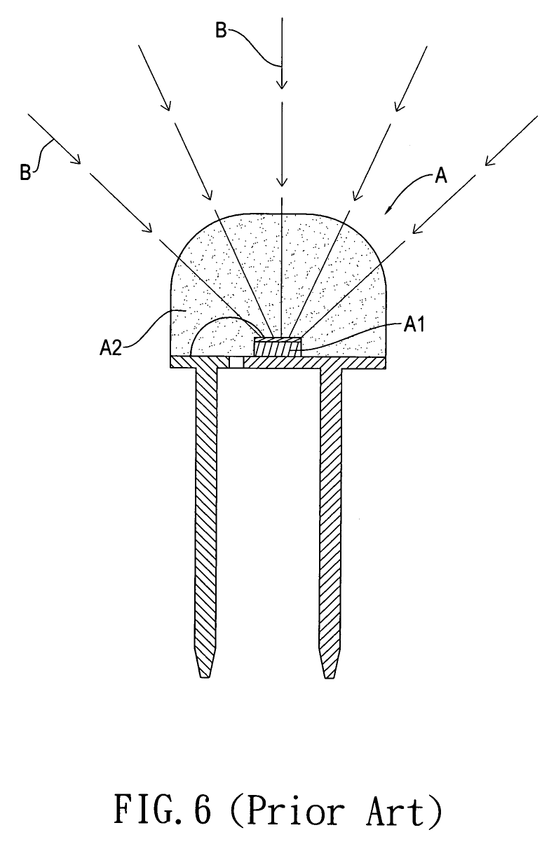

### DETAILED DESCRIPTION OF THE PREFERRED EMBODIMENTS

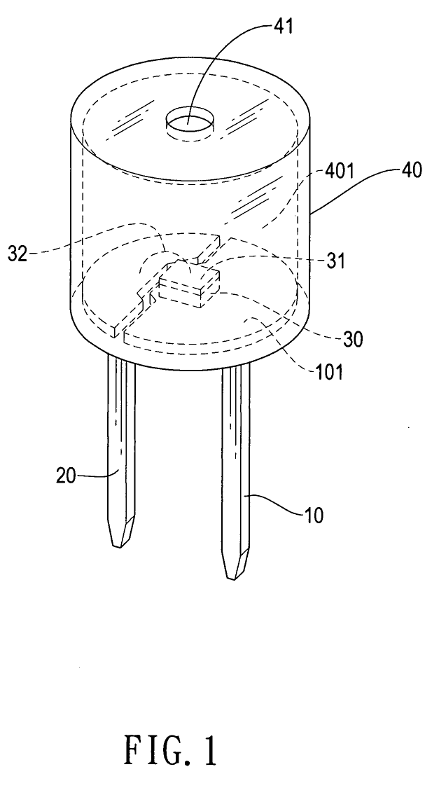

With reference to FIGS. 1-4, a photo detection device constructed in accordance with the present invention comprises two lead frames, a photo detection die 30, and an enclosure 40. The two lead frames include a first lead frame 10 and a second lead frame 20. The first lead frame 10 forms a carriage section 101. The photo detection die 30 is provided with a coating layer 31. The photo detection die 30 is mounted on the carriage section 101 of the first lead frame 10 and the photo detection die 30 forms electrical connection with the second lead frame 20 by means of a conductor 32. The enclosure 40 is a non-light-transmittable member and forms therein a receiving space 401. The enclosure 40 is mounted on the first lead frame 10 and the second lead frame 20 and receives the photo detection die 30 in the receiving space 401 thereof. The enclosure 40 has a top wall (not labeled) forming an opening 41, whereby light is allowed to transmit into the interior of the enclosure 40 through the opening 41 of the enclosure 40 to be detected by the photo detection die 30. In this way, an angle by which an invisible light of a long wavelength, such as an infrared light, is incident on the photo detection die 30 can be reduced so as to prevent the photo detection die 30 from detecting the long wavelength invisible light, such as an infrared light, whereby a photo detection device with high detection reliability is realized.

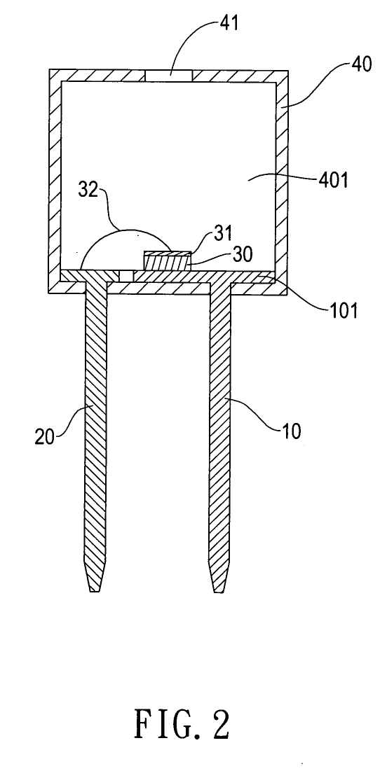

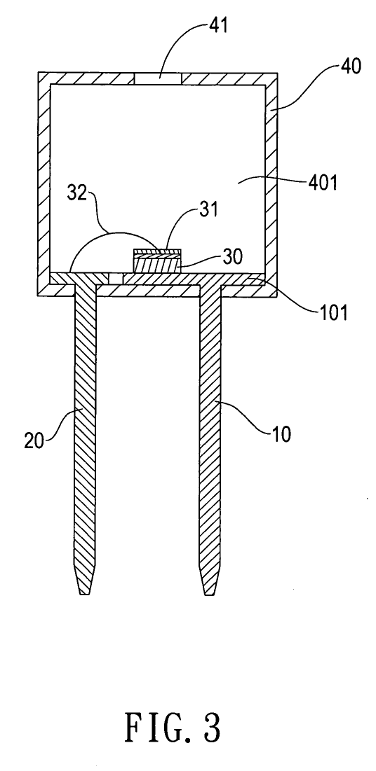

A shown in FIG. 2, the coating layer 31 provided on the photo detection die 30 is to reflect the long wavelength invisible light, such as infrared light. The coating layer 31 is formed by a layer of titanium dioxide (TiO₂) or a layer of silicon dioxide (SiO₂); or alternatively, as shown in FIG. 3, the coating layer 31 is formed of at least one layer of titanium dioxide (TiO₂) and at least one layer of silicon dioxide (SiO₂) that are stacked over each other; or further alternatively, the coating layer 31 can be a Bragg reflection film, whereby reflection of for example the long wavelength invisible light, such as an infrared light, can be enhanced. The enclosure 40 is made of a light-reflecting or non-light-transmitting material comprising a light absorption material or a light reflection material, such as metals. The enclosure 40 is formed as a sleeve for fitting over the photo detection die 30 with the opening 41 formed in the top wall of the enclosure 40 limiting the angle that light projects into the interior of the enclosure 40.

Researches and experiments conducted by the present inventor reveal that when the incidence angle of light is less than 20 degrees, a long wavelength invisible component of an incident light, such as an infrared component, can be reflected by the coating layer 31 of the photo detection die 30. The term “incidence angle” used herein is defined as an included angle between an incident light beam and a line perpendicular to a surface of the photo detection die 30, namely an included angle between the incident light beam and the normal of the surface of the photo detection die 30. The experiments also show that with the incidence angle of the long wavelength invisible light, such as infrared light, getting greater, the long wavelength invisible light can transmit through the coating-layer 31 of the photo detection die 30 more easily to be detected by the photo detection die 30. Thus, based on the result of the experiments, the photo detection device can be improved by reducing the incidence angle of the incident light beam in order to reduce the possibility of error detection of the photo detection die 30 caused by long wavelength invisible light components.

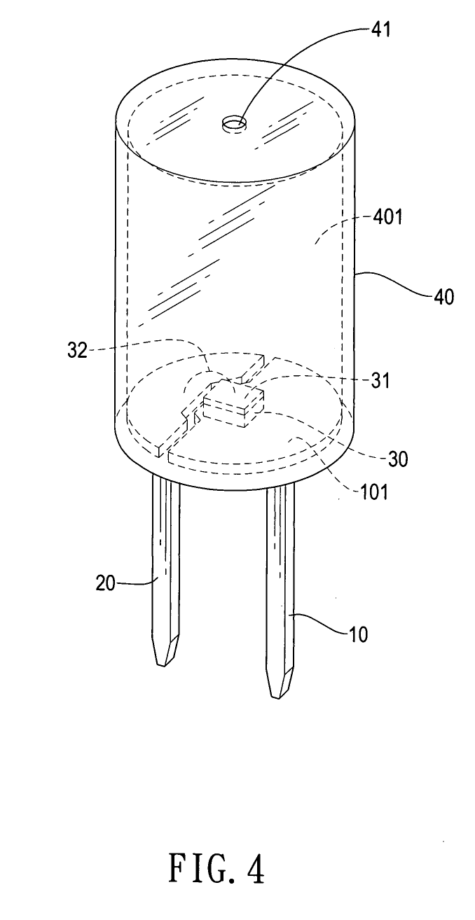

As shown in FIG. 4, in a practical application, the opening 41 of the enclosure 40 can be made smaller to further reduce the incidence angle by which a light is incident onto the photo detection die 30 by transmitting through the opening 41 of the enclosure 40 to get into the enclosure 40. Alternatively, the height of the enclosure 40 can be increased, namely increasing the vertical distance between the opening 41 of the top wall of the enclosure 40 and the photo detection die 30 set inside the enclosure 40, to achieve the same result of limiting the incidence angle of the incident light into the enclosure 40 within a given range, whereby the situation that the long wavelength invisible components of the incident light cannot be effectively reflected by the coating layer 31 on the surface of the photo detection die 30 due to large incidence angles can be avoided. Both arrangements of reducing the opening 41 of the enclosure 40 and increasing the height of the enclosure 40 can be practiced individually or in combination to realize the purpose of the present invention.

Referring to FIGS. 1-4, the present invention features a combination of the first and second lead frames 10, 20, the photo detection die 30 and the enclosure 40 with the enclosure 40 shielding the photo detection die 30 and forming an opening 41 for the transmission of light therethrough, whereby the incidence angle of the light received by the photo detection die 30 is limited in order to prevent error detection caused by a long wavelength invisible component of the incident light, such as an infrared light component, being not reflected by and transmitting through the coating layer 31 of the photo detection die 30 due to the large incidence angle thereof, thereby enhancing the detection reliability of the photo detection die 30. Further, by further reducing the size of the opening 41 of the enclosure 40, the light transmitting through the opening 41 of the enclosure 40 is only allowed to have a reduced incidence angle with respect to the photo detection die 30, whereby the same problem of error detection caused by a long wavelength invisible component of the incident light, such as an infrared light component, transmitting through the coating layer 31 of the photo detection die 30 due to the large incidence angle thereof is avoided. Further, the present invention also provides a solution of increasing the height of the enclosure 40, which leads to an increased distance between the opening 41 of the enclosure 40 and the photo detection die 30, which in turn reduces the angle by which the incident light transmitting into the enclosure 40 is projected onto the photo detection die 30, whereby the problem of error detection of the photo detection die 30 caused by a long wavelength invisible component of the incident light, such as an infrared light component, transmitting through the coating layer 31 of the photo detection die 30 due to the large incidence angle thereof is avoided. Also, with the coating layer 31 of the photo detection die 30 being formed by a layer of titanium dioxide (TiO₂) or a layer of silicon dioxide (SiO₂) or a stack of at least one layer of titanium dioxide (TiO₂) and at least one layer of silicon dioxide (SiO₂), or a Bragg reflection film, reflection of long wavelength invisible lights, such as an infrared light, effected by the photo detection die 30 can be enhanced, whereby error detection can be further reduced to improve the detection reliability of visible lights.

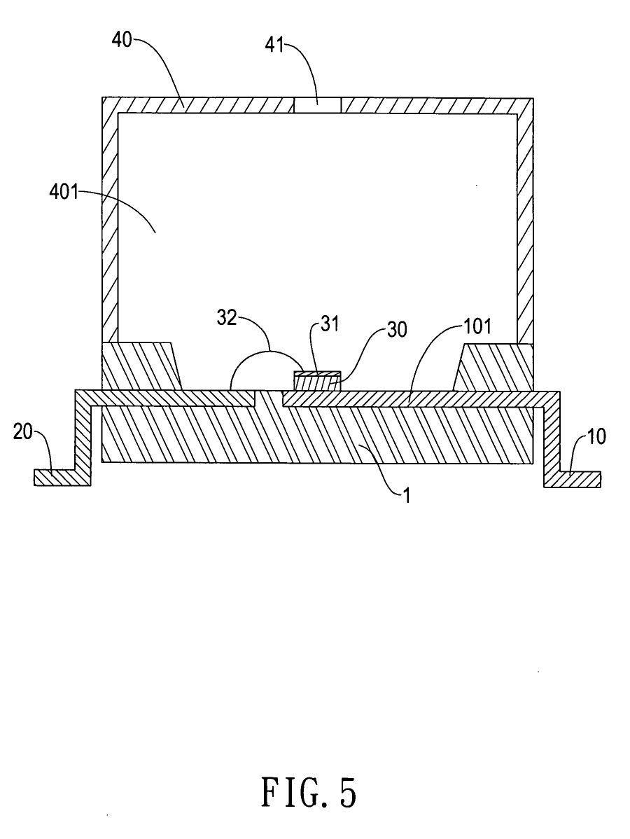

Further, although the photo detection device of the present invention as shown in FIGS. 1-4 is embodied in a DIP (Dual In-line Package) package, wherein the photo detection device comprises a combination of two lead frames (namely the first lead frame 10 and the second lead frame 20), a photo detection die 30, and a enclosure 40, yet it is possible to embody the present invention in an SMD (Surface Mount Device) package, as illustrated in FIG. 5, wherein the SMD packaged photo detection device in accordance with the present invention comprises a base 1, a photo detection die 30, and a enclosure 40. The base 1 is provided with two lead frames, which are set in a bent configuration and extend from inside the base 1 to get beyond opposite sides of the base 1. The two lead frames include a first lead frame 10 and a second lead frame 20. The first lead frame 10 forms a carriage section 101. The photo detection die 30 is provided with a coating layer 31. The photo detection die 30 is mounted on the carriage section 101 of the first lead frame 10 and the photo detection die 30 forms electrical connection with the second lead frame 20 by means of a conductor 32. The enclosure 40 is a non-light-transmittable member and forms therein a receiving space 401. The enclosure 40 is mounted on the base 1 and receives the photo detection die 30 in the receiving space 401 thereof. The enclosure 40 has a top wall (not labeled) forming an opening 41 to allow light to be detected by the photo detection die 30. Similar to the embodiments described with reference to FIGS. 1-4, the coating layer 31 can be formed by for example any of a layer of titanium dioxide, a layer of silicon dioxide, a stack of at least one layer of titanium dioxide and at least one layer of silicon dioxide, and a Bragg reflection film. Further, the enclosure 40 can be made of a light reflection material, such as metals, or a light absorption material. Further, similar to what discussed above in the previous embodiments, the opening 41 of the enclosure 40 can be reduced in size and/or the height of the enclosure 40 increased to enhance reflection of a long wavelength invisible light, such as an infrared light, effected by the photo detection die 30 to thereby reduce the occurrence of error detection and improve the detection reliability of the visible light.

Although the present invention has been described with reference to the preferred embodiments thereof, it is apparent to those skilled in the art that a variety of modifications and changes may be made without departing from the scope of the present invention which is intended to be defined by the appended claims.

1. A photo detection device, comprising:
two lead frames, including a first lead frame and a second lead frame, the first lead frame forming a carriage section;
a photo detection die, comprising a coating layer, the photo detection die being mounted on the carriage section of the first lead frame and forming electrical connection with the second lead frame through a conductor; and
an enclosure, having a non-light-transmittable member forming therein a receiving space, the enclosure being mounted on the first and second lead frames and receiving the photo detection die in the receiving space thereof, the enclosure having an opening formed in a portion of the non-light-transmittable member spaced from the photo detection die, the enclosure being configured to limit light passage through the opening for detection by the photo detection die to light within an incidence angle limit defined according to the coating layer.

2. The photo detection device as claimed in claim 1, wherein the coating layer of the photo detection die comprises a layer of titanium dioxide.

3. The photo detection device as claimed in claim 1, wherein the coating layer of the photo detection die comprises a layer of silicon dioxide.

4. The photo detection device as claimed in claim 1, wherein the coating layer of the photo detection die comprises a stack of at least one layer of titanium dioxide and at least one layer of silicon dioxide.

5. The photo detection device as claimed in claim 1, wherein the coating layer of the photo detection die comprises a Bragg reflection film.

6. The photo detection device as claimed in claim 1, wherein the enclosure is made of a light reflection material.

7. The photo detection device as claimed in claim 1, wherein the enclosure is made of a light absorption material.

8. A photo detection device, comprising:
a base, comprising two lead frames set in a bent configuration and extending from inside the base to beyond opposite sides of the base, the two lead frames including a first lead frame and a second lead frame, the first lead frame forming a carriage section;
a photo detection die, comprising a coating layer, the photo detection die being mounted on the carriage section of the first lead frame and forming electrical connection with the second lead frame through a conductor; and
an enclosure, having a non-light-transmittable member forming therein a receiving space, the enclosure being mounted on the base and receiving the photo detection die in the receiving space thereof, the enclosure having an opening formed in a portion of the non-light-transmittable member spaced from the photo detection die, the enclosure being configured to limit light passage through the opening for detection by the photo detection die to light within an incidence angle limit defined according to the coating layer.

9. The photo detection device as claimed in claim 8, wherein the coating layer of the photo detection die comprises a layer of titanium dioxide.

10. The photo detection device as claimed in claim 8, wherein the coating layer of the photo detection die comprises a layer of silicon dioxide.

11. The photo detection device as claimed in claim 8, wherein the coating layer of the photo detection die comprises a stack of at least one layer of titanium dioxide and at least one layer of silicon dioxide.

12. The photo detection device as claimed in claim 8, wherein the coating layer of the photo detection die comprises a Bragg reflection film.

13. The photo detection device as claimed in claim 8, wherein the enclosure is made of a light reflection material.

14. The photo detection device as claimed in claim 8, wherein the enclosure is made of a light absorption material.

15. The photo detection device as claimed in claim 1, wherein the coating layer is substantially reflective to an invisible component of light incident thereon within the incidence angle limit, and at least partially transmissive to an invisible component of light incident thereon beyond the incidence angle limit.

16. The photo detection device as claimed in claim 15, wherein the incidence angle limit is 20 degrees relative to an axial reference normal to the coating layer.

17. The photo detection device as claimed in claim 8, wherein the coating layer is substantially reflective to an invisible component of light incident thereon within the incidence angle limit, and at least partially transmissive to an invisible component of light incident thereon beyond the incidence angle limit.

18. The photo detection device as claimed in claim 17, wherein the incidence angle limit is 20 degrees relative to an axial reference normal to the coating layer.
